(19) United States
(12) Patent Application Publication
(10) Pub. No.: US 2015/0029844 A1
(43) Pub. Date: Jan. 29, 2015

(54) METHOD AND A COMMUNICATION TERMINAL FOR MODULATING A MESSAGE FOR TRANSMISSION IN A WIRELESS COMMUNICATION NETWORK

(71) Applicant: Agency for Science, Technology and Research, Singapore (SG)

(72) Inventors: Jaya Shankar s/o Pathmasuntharam, Singapore (SG); Zhongding Lei, Singapore (SG); Haiguang Wang, Singapore (SG); Anh Tuan Hoang, Singapore (SG); Shoukang Zheng, Singapore (SG); Wai Leong Yeow, Singapore (SG); Chee Ming Joseph Teo, Singapore (SG)

(73) Assignee: Agency for Science, Technology and Research, Singapore (SG)

(21) Appl. No.: 14/357,023

(22) PCT Filed: Nov. 9, 2012
(86) PCT No.: PCT/SG2012/000426

§ 371 Date: May 8, 2014

(30) Foreign Application Priority Data
Nov. 9, 2011 (SG) SG201108265-8

(51) Int. Cl. H04W 28/02

(52) U.S. Cl. CPC H04W 28/0289
USPC 370/230

(57) ABSTRACT

The present invention is directed to a communication terminal in a wireless communication network. The communication terminal includes a receiver configured to receive a first message comprising a media access control (MAC) frame at a first transmission rate from a communication device in the wireless communication network; a message generator configured to generate a second message in response to the received first message, the second message comprising a control response frame; and a transmitter configured to transmit the control response frame at a second transmission rate, wherein the second transmission rate is lower than or equal to the first transmission rate; and wherein the second transmission rate is dependent on a difference in qualities between downlink communication and uplink communication between the communication device and the communication terminal. Methods of modulating a message for transmission in the wireless communication network are also disclosed.

### CROSS-REFERENCE TO RELATED APPLICATION

This application claims the benefit of priority of Singapore patent application No. 201108265-8, filed 9 Nov. 2011, the content of it being hereby incorporated by reference in its entirety for all purposes.

### TECHNICAL FIELD

Various embodiments generally relate to the field of communication terminals in a wireless communication network and methods for a message transmission in the wireless communication network.

### BACKGROUND

For most, if not all, of the service providers (SPs), it is a challenge to satisfy the demand on network capacity from mobile data traffic solely by upgrading existing equipment or building up more new cells due to the cost and shortage of radio resources. On the other hand, since almost every smart phone comes with a WiFi chipset, a promising alternative is for the SPs to build up WiFi networks and offload as much as possible cellular data traffic to WiFi. This is because the cost on deploying WiFi hot spot is relatively lower and the corresponding radio frequency band is free. Millions of Access Points (APs) are expected to be deployed by SPs.

The cost savings with WiFi offload are projected to be significant. SPs deploying a multi-access (WiFi and 3G) offload strategy can expect savings in the range of about 20% to about 25% per annum. A significant increase in the number of connections from some SPs' hotspots was observed, for example, from 19.7 million connections in 2008 to 86.2 million connections in 2009. This translated to a growth of about 400%. In the US market, SPs may save between US$30˜US$40 billion per year by 2013.

WiFi offload helps SPs provide better mobile data service with lower costs. However, a number of challenges (e.g., asymmetric link) prevent the WiFi offload technology from being exploited to its full potential.

WiFi coverage is determined by the radio transmission power, antenna gain and propagation path loss.

The overall emitted transmission power is under government regulations. The transmit power limit for WiFi normally ranges from 1 to 4W EIRP (Equivalent Isotropically Radiated Power) for isotropic point-to-multiple-points (PMP) mode depending on the jurisdiction of use. Such power limit is normally sufficient for an access point (AP) to reach a coverage distance of around 1 km (based on downlink transmission), with a high-gain antenna and placed at roof top. On the other hand, the power level in mobile phone is normally lower and the antenna gain is limited due to the constraint of cost, power consumption, or form factors etc. The antenna height at the mobile phone is restricted by the environment and not likely to be changed arbitrarily. These restrictions and constraints lead to a much smaller reach from mobile phone to AP (based on uplink transmission) which is typically less than 50 m in an indoor environment. The difference in transmission range causes an asymmetric downlink and uplink connectivity between APs and mobile phones and causes the de facto coverage of APs to be shortened by a few or many folds.

In downlink transmission, AP may transmit to the mobile with much higher power on top of a high antenna gain. It is expected the downlink throughput or coverage may be significantly higher and scaled to the transmission power. However, the downlink throughput or coverage does not improve any further beyond certain range. The reason lies in the poorer uplink connectivity. This is because a downlink data transmission cycle in WiFi requires uplink control signaling to complete. Downlink throughput or coverage is in fact bottlenecked by the uplink control signaling transmission.

For example, a mobile station may receive data from an AP in downlink but it is unable to send back acknowledgement (ACK) messages correctly to the AP. Without the ACK message(s) received, the AP would keep on transmitting the same data until time out.

In another example, when the AP sends out a request-to-send message (RTS) in downlink but does not receive an uplink clear-to-send message (CTS) due to poorer uplink connectivity. It is not allowed to transmit data since this is considered as collision or channel being occupied by other devices or terminals. The asymmetric link may also cause timeout for the association between a mobile station and the AP. Consequently, downlink throughput or coverage is in fact bottlenecked by the uplink control signaling transmission.

Thus, there is a need to provide a communication terminal and a method of modulating a message for transmission seeking to address at least the problems above caused by the WiFi asymmetric link phenomenon for any WiFi which may or may not be deployed by SPs.

### SUMMARY OF THE INVENTION

In a first aspect, the present invention relates to a communication terminal in a wireless communication network. The communication terminal includes a receiver configured to receive a first message comprising a media access control (MAC) frame at a first transmission rate from a communication device in the wireless communication network; a message generator configured to generate a second message in response to the received first message, the second message comprising a control response frame; and a transmitter configured to transmit the control response frame at a second transmission rate, wherein the second transmission rate is lower than or equal to the first transmission rate; and wherein the second transmission rate is dependent on a difference in qualities between downlink communication and uplink communication between the communication device and the communication terminal.

According to a second aspect, the present invention relates to a method of modulating a message for transmission in a wireless communication network. The method includes receiving a first message comprising a media access control (MAC) frame at a first transmission rate from a communication device in the wireless communication network; generating a second message in response to the received first message, wherein the second message comprises a control response frame; and transmitting the control response frame at a second transmission rate, wherein the second transmission rate is lower than or equal to the first transmission rate; and wherein the second transmission rate is dependent on a difference in qualities between downlink communication and uplink communication between the communication device and the communication terminal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features/elements may be arbitrarily expanded or reduced for clarity. In the following description, various embodiments of the invention are described with reference to the following drawings, in which:

FIG. 1 shows an Orthogonal frequency-division multiplexing (OFDM) PLCP frame format;

FIG. 2 shows a communication terminal, in accordance to various embodiments;

FIG. 3 shows a flow diagram of a method of modulating a message for transmission in a wireless communication network, in accordance to various embodiments;

FIG. 4 shows an ACK frame transmission at mobile, in accordance to various embodiments;

FIG. 5 shows an ACK message with the transmission rate of an ACK frame fixed with that of a SIG field, in accordance to various embodiments;

FIG. 6 shows an ACK message with a transmission mode of both a SIG and an ACK frame being introduced and modified, in accordance to various embodiments;

FIGS. 7A and 7B show examples of symbol repetition in an OFDM system, in accordance to various embodiments;

FIGS. 8A and 8B show examples of ACK messages with only preambles, in accordance to various embodiments;

FIGS. 9A and 9B show examples of ACK messages with only preambles and having addressing capabilities, in accordance to various embodiments;

FIG. 10 shows an example of preamble only transmission having limited addressing capability, in accordance to various embodiments;

FIGS. 11A and 11B show examples of ACK messages with enhanced preamble and SIG/ACK frame, in accordance to various embodiments; and

FIG. 12 shows an example of an ACK message of FIGS. 11A and 11B without the SIG, in accordance to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In order that the invention may be readily understood and put into practical effect, particular embodiments will now be described by way of examples and not limitations, and with reference to the figures.

Various embodiments may provide reliable uplink control signaling for efficient transmission in asymmetric communication traffic.

Various embodiments may provide methods of cellular-WIFI offloading.

In various embodiments, a method for asymmetrical downlink and uplink data communication between access points and mobile stations may be provided to increase transmission reliability of Physical Layer Convergence Procedure (PLCP) for uplink signals from the mobile station (MS) and to match the quality of downlink data signal transmission from the access point.

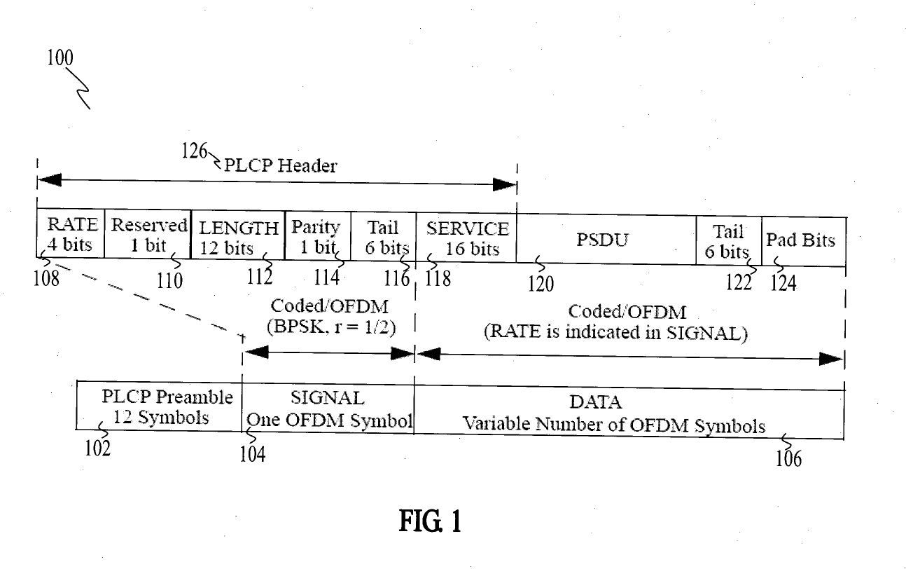

FIG. 1 shows an Orthogonal frequency-division multiplexing (OFDM) PLCP frame format 100 in current IEEE 802.11 standard. The PLCP frame 100 includes three parts: the PLCP preamble 102, the SIGNAL 104, and the DATA 106. The PLCP Preamble 102 is composed of a short training field (ST) or 10 repetitions of a “short training sequence” and a long training field (LT) or two repetitions of a “long training sequence” preceded by a guard interval (GI), (not shown in FIG. 1) used for AGC (automatic gain control) convergence, diversity selection, timing acquisition, and coarse frequency acquisition and channel estimation and fine frequency acquisition in a receiver respectively. The SIGNAL part 104 contains the control information such as data rate 108, reserved bit 110, length 112, parity bit 114, tail 116, etc. In terms of modulation, the SIGNAL 104 is transmitted with the most robust ½ A rate binary phase shift keying (BPSK) modulation. The DATA part 106 is transmitted at the data rate 108 dependant on the DATA type and indicated in the SIGNAL 104. The DATA part 106 contains SERVICE bits 118, Physical Layer Service Data Unit (PSDU) 120, tail 122, and pad bits 124. The SIGNAL 104 and the SERVICE bits 118 forms the PLCP header 126.

For ACK signals, the ACK frame is encoded in DATA part 106 and transmitted following the PLCP preamble 102 and the SIGNAL 104. The transmission rate of the uplink ACK frame encoded in the DATA part 106 is at least substantially the same to the transmission rate of downlink data frame received at the mobile. For example, according to IEEE 802.11-2012 standard, an ACK frame responding to a received frame is transmitted at either a primary rate or an alternate rate. The primary rate is defined to be the highest rate in the Basic Rate Set or highest mandatory rate that is less than or equal to the rate of the received frame. An alternate rate meets the requirement that the resulting duration of frame is the same as the duration of the frame at the primary rate.

The term “mandatory rate” is a transmission rate that is allocated under the IEEE 802.11 standard for communication. For example, the IEEE standard 802.11b permits communication in 1, 2, 5.5 and 11 Mbps; and the IEEE standard 802.11a permits communication in 6, 9, 12, 18, 24, 36, 48 and 54 Mbps. The IEEE standard 802.11g permits communication in any of the data rates defined in the IEEE standard 802.11b and the IEEE standard 802.11a, and dictates that support for 1, 2, 5.5, 11, 6, 12 and 24 Mbps is mandatory (i.e., as mandatory rates).

Various embodiments may provide a communication terminal (e.g., a station or mobile) to generate and transmit an ACK message upon receiving another message (e.g. a data packet/frame, a control or management frame) from a communication device (e.g. AP). The ACK message may include preambles, a SIGNAL field and an ACK frame (i.e., the DATA part 106 of FIG. 1). According to the current IEEE 802.11 standard, the SIGNAL field is transmitted using the most reliable modulation and coding scheme (MCS), whereas the MCS of the ACK frame is selected to be close to the MCS of the previous frame to which the ACK frame responds. In general, the MCS of the ACK frame is the highest Basic Rate or a mandatory rate that is less than or equal to the transmission rate of the previous frame.

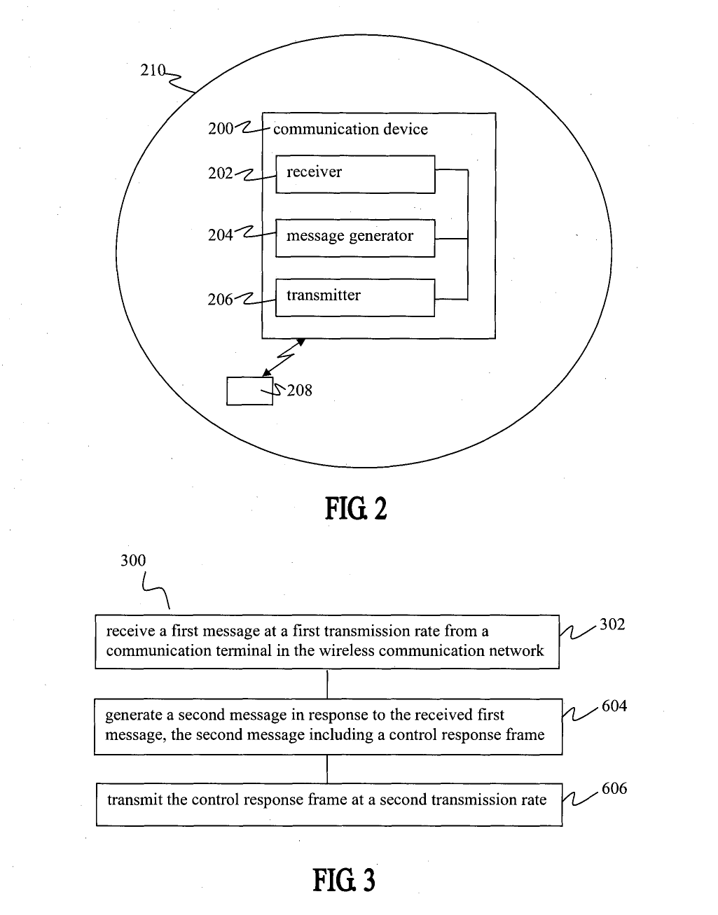

In a first aspect, a communication terminal in a wireless communication network is provided as shown in FIG. 2. In FIG. 2, the communication terminal 200 includes a receiver 202 configured to receive a first message at a first transmission rate from a communication device 208 in the wireless communication network 210; a message generator 204 configured to generate a second message in response to the received first message, the second message comprising a control response frame; and a transmitter 206 configured to transmit the control response frame at a second transmission rate, wherein the second transmission rate is lower than or equal to the first transmission rate; and wherein the second transmission rate is dependent on a difference in qualities between downlink communication and uplink communication between the communication device and the communication terminal.

As used herein, the term “communication terminal” may refer to a machine that assists data transmission, that is sending and/or receiving data information. Accordingly, the communication terminal may also be generally referred to as a node. For example, a communication terminal may be but is not limited to, a station (STA), or a substation, or a mobile station (MS), or a port, or a mobile phone, or a computer, or a laptop.

In one embodiment, the communication terminal 200 may include a mobile device or a station.

In the context of various embodiments, the term “communication device” may refer to a node of a network, which communicates directly with the communication terminal. A communication device 208 may be, for example but not limited to, a base station, or a substation, or an access point, or a modem, a cable, or a port. In one embodiment, the communication device 208 may comprise an access point.

In various embodiments, the term “wireless communication network” may be a communication network according to an IEEE 802.11 communication standard. For example, the wireless communication network 210 may be a WiFi network. The WiFi network may be a WiFi which may be deployed by service providers (SPs) or a WiFi which may not be deployed by SPs.

In some examples, the receiver 202 and the transmitter 206 may be combined into a single package, referred to as a transceiver. In general, a transceiver comprises both transmitting and receiving capabilities and functions.

As used herein, the term “transmission rate” generally refers to the rate at which a message (or signal) or a part thereof is transmitted from one entity to another. In this context, the transmission rate may be associated with or related to modulation rate and/or coding rate.

Modulation rate may interchangably be referred to as symbol rate or baud rate and is the number of symbol changes (waveform changes or signalling events) made to the transmission medium per second using a digitally modulated signal or a line code. Coding rate or code rate may refer to the proportion of codes in a message or signal with respect to the data that is useful.

In the context of various embodiments, the second transmission rate being lower than or equal to the first transmission rate refers to the control response frame being transmitted (at the second transmission rate) with a more reliable modulation and coding scheme (MCS) than that of the first message, which is transferred at the first transmission rate. The second transmission rate may be fixed at a most reliable rate for the control response frame. Transmission of the control response frame is performed by using a (much) lower rate than that used for the received message to counter asymmetrical transmission problem as described herein.

In one embodiment, the first transmission rate may be used to determine a primary rate; and the control response frame may have a first frame duration when transmitting at the second transmission rate, the first frame duration being longer than a second frame duration, wherein the second frame duration is determined by transmitting the control response frame at the primary rate. The term “primary rate” may be defined as above in the context of the IEEE 802.11 standard.

For illustrative purposes only, an example on the relationship between the second transmission rate and the primary rate may be provided as follow. In the current IEEE 802.11 standard, the closest (lower) mandatory/Base rate to the uplink transmission rate (e.g., similar to the second transmission rate) is used for the control response frame. For example, there are assumed 10 mandatory rates (i.e. Modulation and Coding Schemes or MCS 0-9) supported in a system and the higher MCS number, the higher rate. If the downlink transmission uses a rate MCS9, the current IEEE 802.11 standard requests the control response frame to use the primary rate MCS 9. In contrast, various embodiments of the present invention uses a lower second transmission rate (i.e., rates MCS 0 to MCS 8) depending on the degree of asymmetry between the uplink and downlink connectivity. If the degree is only of one rate difference, the rate #8 (i.e., one level lower) is used. If the degree is nine rate differences, the rate MCS 0 (i.e., nine level lower) is used.

In another example, it is assumed MCS 9 is an optional rate and not a rate in the Basic rate set. If the downlink transmission uses the rate MCS 9, the current IEEE 802.11 standard requests the control response frame to use the rate MCS 8 since MCS 8 in this case is the primary rate. The rate MCS 8 is lower than the rate MCS 9. In this example, various embodiments of the present invention uses a much lower second transmission rate (i.e., any rate lower than rate MCS 8).

In the context of various embodiments, the term “message” generally refers to a short information sent from one entity to at least another one entity. A message may be a packet or a cluster.

The term “qualities” is mainly decided by the frequency of transmission and the characteristics of the transmission media.

In one embodiment, the difference in qualities may include at least one of a difference in transmission ranges, a difference in transmission power levels, a difference in transmission or receiving antenna gain, a difference in throughputs or coverages, or a difference in connectivities.

The second transmission rate being lower than or equal to the first transmission rate, and the second transmission rate being dependent on the difference in qualities between downlink communication and uplink communication between the communication device and the communication terminal causes uplink transmission reliability from the communication terminal to match the quality of downlink transmission from the communication device.

In various embodiments, the control response frame may include frame check sequence (FCS) bits and at least one of an identification of the communication terminal, and an identification of the communication device.

As used herein, the term “identification” may refer to an address.

In various embodiments, the second transmission rate may be selected from a set of transmission rates for a channel between the communication terminal and the communication device; and each transmission rate in the set may be lower than or equal to the first transmission rate.

The term “channel” refers to a wireless channel for communication between the communication terminal and the communication device.

For example, the second transmission rate may be selected from the set of transmission rates most suitable for the channel, based on a transmission power, an antenna gain, and a capability of the communication terminal.

In various embodiments, the second message may further include a SIGNAL field including information on parity check bits and tail bits. In some example, the information may further include the transmission rate and the length of the control response frame.

The transmitter may be further configured to transmit the SIGNAL field at a third transmission rate; and wherein the second transmission rate is the same as the third transmission rate.

In one embodiment, the third transmission rate may be fixed at a lowest mandatory rate. The term “mandatory rate” may be defined as above, and may refer to a fixed rate provided in the IEEE 802.11 standard. It should be appreciated that the SIGNAL field is transmitted at the most robust rate or at the lowest transmission rate (i.e., with the most reliable MCS). This lowest transmission rate is fixed in a system and is the lowest mandatory rate in the system. In other words, the control response frame may also be transmitted at the most robust rate or at the lowest transmission rate (i.e., with the most reliable MCS) as for the SIGNAL field.

In various embodiments, the SIGNAL field and the control response frame may be arranged to be combined into a single frame or a second SIGNAL field (named as a new SIGNAL field). The SIGNAL field and the control response frame may be combined and compressed. In context of these embodiments, the term “combined” with respect to the combination of SIGNAL field and the control response frame may refer to the SIGNAL field and the control response being appended to each other; or the SIGNAL field and the control response may be encoded to form the single frame or the second SIGNAL frame.

The single frame may contain tail bits, identification (or address) bits and FCS bits. The single frame may be a new SIGNAL field with redundant information removed. In this embodiment, redundant bits, for example, rate and length bits and parity check bits may be omitted. This way, the new SIGNAL field may be shortened; thereby allowing the transmission of this new SIGNAL field to be more efficient.

In various embodiments, the second message may further include a preamble including a short training field (ST) and a long training field (LT) as defined above. The ST field may be composed of repetitions of a short training sequence and the LT field may be composed of repetitions of a long training sequence. The second message comprising the repetition of ST and LT may be transmitted at a new most reliable rate. The new most reliable rate may be different from the most reliable rate that may be used for different constructs of the second message, in accordance to various embodiments.

In some embodiments, the preamble may further include the ST and the LT being repeated for 2 times or more in different predetermined orders. The ST field may include a plurality of short training sequences, and the LT field may include a plurality of long training sequences. The ST field and LT field may be arranged and/or repeated 2 to a number of times in a predetermined order or pattern.

The second message may include the preamble, followed by the SIGNAL field and the control response frame.

For example, the first message may have a higher transmission rate than the second message. The first message may include at least part of a downlink signal. A downlink signal generally refers to a signal being transmitted from an access point to a mobile device. The second message may include at least part of an uplink signal. An uplink signal generally refers to a signal being transmitted from a mobile device to an access point.

The term “in response to” may refer to “acknowledging receipt of” if the second message is an acknowledgement (ACK) frame or signal, being sent in response to the received message (or the first message).

In various embodiments, the control response frame of the second message may include an ACK frame. In some example, the control response frame may include but are not limited to a block ACK frame, or a block ACK (BA) frame, or a Clear-to-Send (CTS) frame.

For example, the first message may be a Request-to-Send message and the second message may be a Clear-to-Send (CTS) message.

In one example, the transmission rate of the control response frame may include a modulation rate ranging from 2 times repetition ½ rate (effectively ¼ rate) Binary Phase Shift Keying (BPSK) to a ¾ rate 64-Quadrature Amplitude Modulation (QAM).

In another embodiment, the control response frame and the SIGNAL field may include a plurality of OFDM symbols, each OFDM symbol including a plurality of symbols; and the message generator 204 may further be configured to generate the second message using the symbols being repeated in a predetermined order. As used herein, the term “OFDM symbol” is different from the term “symbol” as in the “plurality of symbols”. The symbols are repeated within the OFDM symbol. In other word, the message generator 204 may be configured to generate the second message where the symbols being repeated at a subcarrier level in the predetermined order. For example, the message generator 204 may be configured to generate the second message using the symbols being repeated for 2 times, or 3 times, or 4 times, or 5 times, or 6 times, or 7 times, or 8 times or more.

The message generator may be configured to generate the second message using the symbols being repeated in different predetermined orders.

In some examples, the communication terminal 200 may further include a block coder configured to encode the symbols. The block coder may include a space time block coder (STBC) or a space frequency block coder (SFBC). It should be understood that other block coders may also be used.

In one example, the message generator 204 may further be configured to encode the control response frame and the signal field using Forward Error Correction (FEC) coding. For example, the FEC coding may include ½ rate low-density parity-check (LDPC) coding, or turbo coding, or product coding. It should be understood that forms of encoding may also be appropriate to encode the control response frame and the signal field.

In a second aspect, a method of modulating a message for transmission in a wireless communication network 300 is provided as shown in FIG. 3. At 302, a first message comprising a media access control (MAC) frame may be received at a first transmission rate from a communication device in the wireless communication network. At 304, a second message may be generated in response to the received first message, wherein the second message includes a control response frame. At 306, the control response frame may be transmitted at a second transmission rate, wherein the second transmission rate is lower than or equal to the first transmission rate; and wherein the second transmission rate is dependent on a difference in qualities between downlink communication and uplink communication between the communication device and the communication terminal.

In various embodiments, the method 300 may further include transmitting the SIGNAL field at a third transmission rate, wherein the second transmission rate is the same as the third transmission rate.

In one embodiment, transmitting the control response frame 306 and the SIGNAL field may include transmitting the control response frame and the SIGNAL field in a single frame or as a new SIGNAL field.

The terms “message”, “first message”, “second message”, “wireless communication network”, “communication device”, “in response to”, “control response frame”, “signal field”, “transmission rate”, “single frame”, and “qualities” may be as defined above.

In various embodiments, the control response frame and the SIGNAL field may include a plurality of Orthogonal Frequency-Division Multiplexing (OFDM) symbols, each OFDM symbol including a plurality of symbols; and the method may further include generating the second message using the symbols being repeated in a predetermined order.

The term “OFDM symbol” and “symbol” may be defined as above.

In various embodiments, generating the second message may include generating the second message using the symbols being repeated for 2 times, or 3 times, or 4 times, or 5 times, or 6 times, or 7 times, or 8 times or more. Generating the second message may also include generating the second message using the symbols being repeated in different predetermined orders.

Various embodiments may be provided as described in a set of exemplary schemes that enable APs and mobile stations to continue the data communication even if the downlink and uplink between them are asymmetric. Transmission reliability of Physical Layer Convergence Procedure (PLCP) for uplink signals from mobile stations may be increased and match the quality of downlink data signal transmission from AP.

In the various exemplary schemes, the reliability of uplink control signals may be increased to compensate the inferior transmission power and antenna gain as opposed to downlink transmission. The exemplary schemes are described using ACK signals. It should be understood and appreciated that similar schemes may be applied to other control signals such as Block ACK/CTS as well.

Reliable Uplink Control Signaling without PLCP Format Change

Implicative ACK Detection

Various examples may provide a communication device (e.g., AP) including a receiver configured to receive an ACK message from a communication terminal (e.g., mobile) in a wireless communication network, wherein the ACK message has been generated to acknowledge receipt of a downlink data transmitted by the communication device; and a detector configured to detect a part of the ACK message to infer a presence of an ACK frame. The part of the ACK message may include a preamble of the ACK message or a part thereof. The part of the ACK message does not include the ACK frame.

This scheme according to various examples, is in fact a receiver detection scheme. It does not make any modification to the PLCP frame (FIG. 1) or any attempt to enhance the uplink control signaling transmission. Instead, it relies solely on a smart preamble detection to deduce the ACK message. This kind of schemes is based on the fact that the presence of preambles may be detected more reliably than the decoding of other parts of the PLCP, such as SIGNAL field (SIG) (e.g., the SIGNAL 104 of FIG. 1) and ACK frames (e.g., in the DATA 106 of FIG. 1).

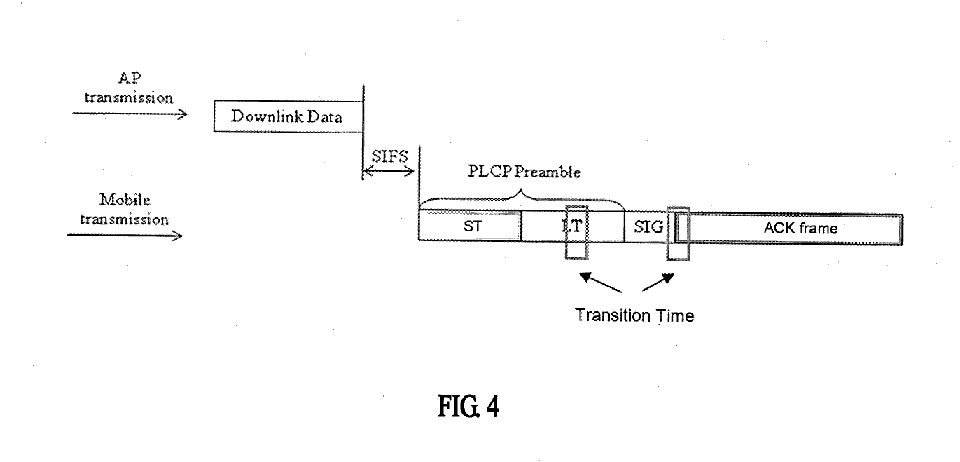

FIG. 4 shows schematically the ACK frame transmission at mobile 400. After receiving downlink data 402 from the AP 404, the mobile station transmits the ACK frame 406, preceded by the PLCP preamble 408, after a fixed short interval, i.e. short inter-frame space (SIFS) 410.

In WiFi, the PLCP preamble 408 has multiple purposes and it is important to perform timing acquisition, frequency acquisition and channel estimation. As the synchronization and channel estimation are crucial to the system performance, the preamble 408 is designed reliably and robust to various scenarios. The first step in before timing/frequency acquisition is to detect the presence of the signal. The sensitivity level for the detection of the presence of the preamble 408 is higher than the decoding of PLCP SIG 412 or most reliable DATA part, with a typical 5 to 6 dB margin for example.

In the Smart Preamble Detection Scheme, this performance margin provided for the preamble 408 may be exploited to increase the reception reliability of the ACK message. Instead of expressly decoding the ACK frame 406 sent by the mobile, the receiver only detects the presence of the preamble 408 for the ACK message and infer the successful reception of data packages by the mobile. As the PLCP preamble 408 for the ACK message is transmitted by the mobile at one SIFS 410 after the AP's downlink data 402, the AP knows the timing to expect an ACK message if the mobile has sent one out.

During this period or detection window, the AP may sense the channel and detect the presence of the preamble 408. One way to detect is to match the receiving signal with the short training (ST) field 414 in the PLCP preamble 408. Another approach is to try to detect the transition time from the ST 414 to the long training field (LT) 416 as shown in FIG. 4.

One may also utilize the LT 416, the transition time 418 from the LT 416 to the SIG 412 or any combination of the ST 414, the LT 416 or the transition time 418 to detect the presence of the preamble 408 of the ACK message sent out by the mobile. Once detected, the AP considers an ACK message is received successfully and proceed with other transmission or process. Since the detection of the presence of preambles has much higher sensitivity than the decoding of a real ACK message, this translates to a longer range of the uplink control signal.

ACK Frame Transmission with Most Reliable Modulation

In the current WiFi specification (standard), the modulation and coding mode for ACK transmission is tied to downlink transmission rate received at mobile. A mobile station responding to a received downlink frame transmits the ACK frame (e.g., the ACK frame 406 of FIG. 4) at the highest Base rate or mandatory rate of the physical layer (PHY) that is less than or equal to the rate of the received frame.

Since SIG field (e.g., the SIG 412 of FIG. 4) is always transmitted at the lowest and most robust modulation mode and the ACK frame may be transmitted with higher modulation than the SIG, the AP may be able to decode the SIG but encounter errors in decoding the ACK packets.

In various embodiments, the modulation and coding rates of the ACK frame is lowered to the same level as the SIG field when asymmetric link appears and the ACK message is sent on the uplink.

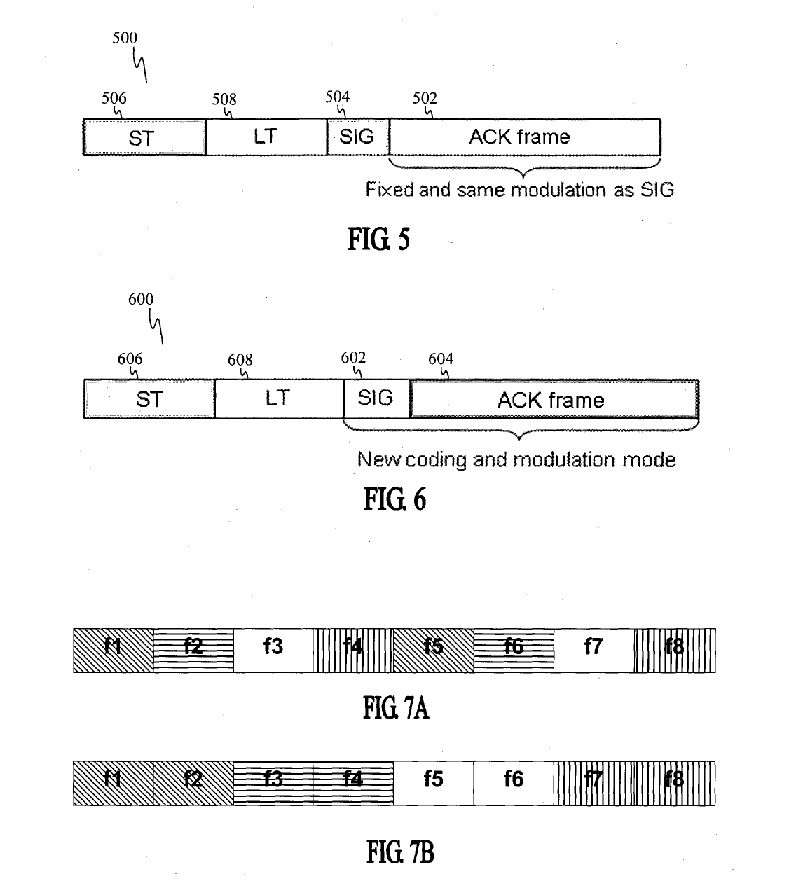

FIG. 5 shows an ACK message 500 with the transmission rate of the ACK frame 502 fixed with that of the SIG 504 field, in accordance to various embodiments. The ACK message 500 may include ST 506 and LT 508, which may refer to ST 414 and LT 416 of FIG. 4.

For example, the ACK frame 502 and the SIG 504 may refer to the control response frame and the SIGNAL field of the second message generated by the message generator 204 of FIG. 2.

The gain in terms of reliability or coverage of the ACK transmission may be significant and may be dependent on the modulation and coding rate of the downstream data used, which is followed by the original ACK frame transmission. For example, the gain from using ½ rate BPSK ACK frame may range from 3-17 dB, if downlink transmission is from ½ rate QPSK to ¾ rate 64-QAM.

As the modulation and coding rates of SIG field and ACK frame are the same, i.e., the most reliable rate, the SIG field and ACK frame may be combined to give a new SIG field. The redundent information may be removed to increase efficiency. For example, there is rate and length field in the original SIG. Since the rate of ACK frame is fixed, there is no need to have the rate indication in the SIG field. The length of the ACK frame is fixed and the length field in SIG field is also redundent. The tails bits and parity bit in SIG field may be merged with tails bits and FCS bits in ACK frame respectively.

Transmission of ACK frame and SIG Field with New Modulation

In the above section of “ACK Frame Transmission with Modulation”, the modulation mode of ACK frame transmission is modified in order to increase the reliability of ACK frame.

In order to improve the reliability of ACK transmission further and push the performance boundary under the current PLCP preamble format, the modulation and coding mode for the transmission of SIG field and ACK frame may be enhanced by introducing new modulation or FEC coding. This is based on the assumption that the reliability provide by the PLCP preamble (e.g., the preamble 408 of FIG. 4) has a higher margin than the decoding of SIG field which is currently coded by a BPSK modulated ½-rate convolutional code. Improving the reliable of the BPSK modulation or ½ rate convolutional code closes the performance gap between the preamble (e.g., the preamble 408 of FIG. 4) and the SIG field (e.g., the SIG 412 of FIG. 4) and thus extends the reach of the ACK frame transmission.

FIG. 6 shows an ACK message 600 with a transmission mode of both a SIG 602 and an ACK frame 604 being introduced and modified. The ACK message 600 may include ST 606 and LT 608, which may refer to ST 414 and LT 416 of FIG. 4, or ST 506 and LT 508 of FIG. 5. This reflects further changes to the current WiFi specification. For example, the ACK frame 604 and the SIG 602 may refer to the control response frame and the SIGNAL field of the second message generated by the message generator 204 of FIG. 2.

One way to improve the reliability of the current BPSK and ½-rate convolutional coding is introducing symbol repetition in the OFDM transmission.

Two examples of symbol repetition in OFDM system are illustrated in FIGS. 7A and 7B where f1 to f8 are representing the subcarriers and the shadings are representing data transmitted on the subcarriers. In these two examples (FIGS. 7A and 7B), each data symbol (shading) may repeated twice but in different patterns. Both repetitions give a 3-dB gain to the transmitted symbols. In order to achieve more gain for OFDM signals, more repetition e.g. 4, 8 times repetition may be needed. It is noted that other patterns are also possible and different pattern may also lead to different implementation complexity, diversity gain and power efficiency. In addition, the repetition may also be further block-coded in a similar way to space time block coding (STBC) or space frequency block coding (SFBC).

Another way to improve the current modulation is to introduce advanced FEC coding schemes in the SIG 602 and the ACK frame 604, for example, ½ rate LDPC, Turbo coding, product codes and various variants or lower rate coding (e.g., ¼ or lower convolutional coding). These advanced FEC coding may have various coding gain over the ½ rate convolutional coding. Since LDPC (low-density parity-check) coding provides an option for data transmission in WiFi, there would be less number of hurdles to introduce the LDPC in the SIG 602 and the ACK frame 604 as opposed to other advanced FEC coding. The advanced FEC coding schemes tend to excel only in high signal-to-noise ratio (SNR) region and introduce substantial decoding complexity at the receiver. It is therefore less attractive as the symbol repetition scheme.

Reliable Uplink Control Signaling with New PLCP Frames or Preambles

All the exemplary schemes described above are based on the current PLCP preambles so as to have limited changes to the current WiFi specifications. The maximum reliability achieved may be bounded by the current preamble performance. Further exemplary schemes without this constraint is described below. These exemplary schemes may achieve significant gains.

Preamble Only Transmission

Various examples may provide a communication terminal (e.g., mobile) including a message generator configured to generate an ACK message in acknowledge receipt of a message from a communication device (e.g., AP) in a wireless communication network. The ACK message may include a preamble having a set of STs and at least one end unit.

In some scenarios, for example as in cellular data offloading, a mobile station is not under interference concern when using WiFi, there is no need for the mobile to transmit the AP addresses and packet size information. In such scenarios, the mobile station only needs to transmit the preamble (e.g., 408, FIG. 4) without the SIG (e.g., 412, FIG. 4) and the DATA (e.g., the ACK frame 406, FIG. 4) portions as mandated in a normal ACK message (e.g. as in FIG. 4) in the current WiFi specification.

The AP needs to detect the presence of the preamble (e.g., 408, FIG. 4) for the ACK message without looking for the SIG (e.g., 412, FIG. 4) and the DATA (e.g., the ACK frame 406, FIG. 4) portions. A reliable detection may be possible as the AP knows the right timing to expect an ACK message in case the mobile has sent one out. The detection methods may be similar to that described above.

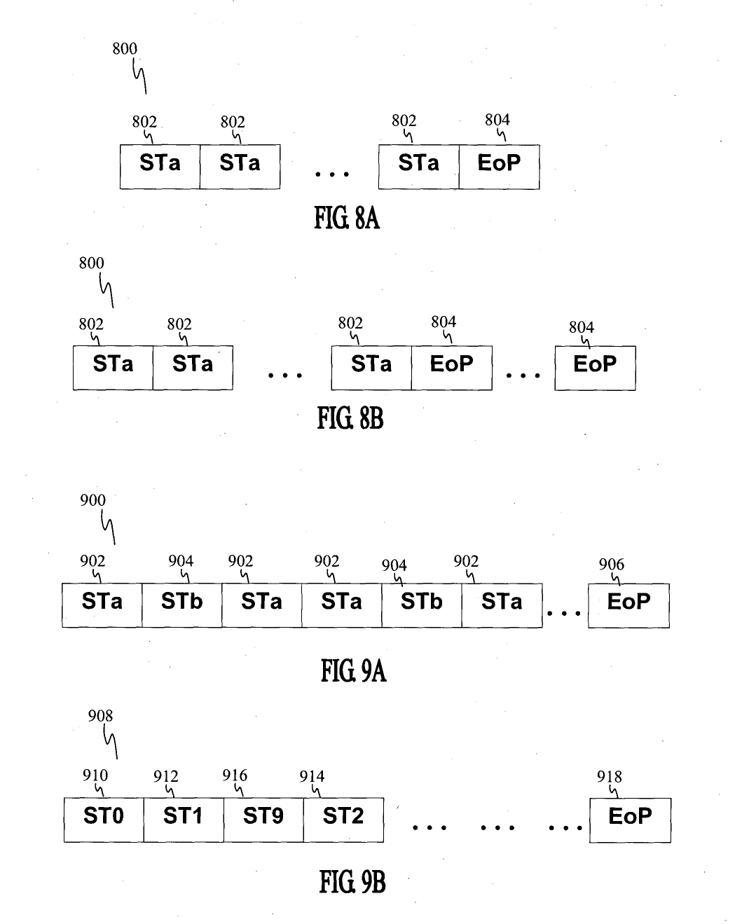

Since only the preamble (e.g., 408, FIG. 4) is transmitted, the preamble may be designed according to the needs for reliability. Examples of such preamble are shown in FIG. 8A. In FIG. 8A, the transmitted preamble 800 includes a number of STs. In FIG. 8A, these STs are labeled as STa 802, instead of ST, to indicate that the components or the basic sequence of STa 802 may be different from that of the current ST (e.g. the ST 414 of FIG. 4). For example, the current ST 414 in FIG. 4 includes 10 short training sequences with duration of 8 μs altogether for 20 MHz OFDM PHY. For the same system, the STa 802 may be made up of only 5 short training sequences with 4 μs duration altogether, since the basic symbol duration in this system is 4 μs which is the same as the CCA (Clear Channel Assessment) time. The first 5 out of the 10 training sequences may used for signal detection.

In designing the number of STa 802, it may be possible to adjust to control the preamble reliability. Doubling the number of STa 802 gives a 3 dB processing gain. The number of STa 802 may be determined according to the target gain to be achieved. In order to facilitate the detection at the receiver (at the AP), the last set of training sequences may be different from the rest to indicate the end of the preamble, EoP 804 as in FIG. 8A. For example, the last ST may be set to negative sign EoP=−STa, i.e., the sign of each of its bit/chip is a reverse to that of previous STa 802. The EoP 804 may employ a different base training sequence than that of STa 802 or ST (e.g., the ST 414 of FIG. 4). The EoF 804 may also be used to correlate the exact 2-way handshake timing. This information may be used at the receiver to increase the detection reliability of the preamble 800.

FIG. 8B shows a variant where multiple EoPs 804 are included in the preamble 800 to increase the detection reliability of the end of the preamble 800. The number of EoPs 804 may be different from that of previous STa 802 and may be smaller.

Preamble with Addressing Capability

Various examples may provide a communication terminal (e.g., mobile) including a message generator configured to generate an ACK message in acknowledge receipt of a message from a communication device (e.g., AP) in a wireless communication network. The ACK message may include a preamble having two or more STs with MAC addresses.

The similarity of the preamble only transmission and the implicative ACK detection as described above is that both ACK messages are implied in the preamble. The downside is that both may not deliver the MAC addresses as in a normal ACK message. Therefore it does not provide the capability for an AP to verify the identity of the transmitting station.

As used herein, the term “Media Access Control address” abbreviated as MAC address refers to a unique identifier assigned to network interfaces for communications on the physical network segment. MAC addresses are used for numerous network technologies and most IEEE 802 network technologies including Ethernet. MAC addresses are used in the Media Access Control protocol sub-layer of the OSI reference model.

In the examples described below, the preamble only transmission may be extended with addressing capability.

FIG. 9A shows a set of short training sequences 900. In FIG. 9A, 2 primary set of short training sequences, STas 902 and STbs 904, are used to denote a binary ‘1’ or ‘0’. This is followed by small number of ending EoPs 906. In this scheme, the 48 bit MAC address may be represented in a reduced form address (i.e., less than 48 bits). Since, many neighboring APs are not expected to coexist in the same area, there may be possibility for the APs to be addressed uniquely by this reduced set MAC address. For example, an AP's address may be represented by 8 bits. STa 902 and STb 904 may then be arranged in a manner to form the 8 bit address (FIG. 9A shows 6-bit address of 101101).

To detect the address embedded preamble and decode the address information, the receiver at AP needs to match a received signal with two set of training sequences, STas 902 and STbs 904. Since an AP knows the address of the expected station, e.g. 101101 as in FIG. 9A, it uses sequences STas 902, denoting 1′, to correlate an incoming signal. Once there is a match, the receiver is triggered to correlate the following signal with STbs 904, corresponding to ‘0’. The process continues until the receiver confirms the signal matched to its expected sequence. If there is no match in any stage, the receiver considers that no ACK signal is transmitted/received from the desired the station.

By assigning APs/Stations different set of training sequences, an AP may differentiate the preamble coming from different stations. However, the differentiation capability of FIG. 9A is much limited as compared to the ACK frame with a MAC address. To increase the addressing capability, more short training sequence set may be defined in advance. For example, 64 set of short training sequences, ST₀ ST₁ . . . ST₆₃ may be defined. In such a case, each set of short training sequence may represent a unique 6 bit string (64=2⁶). By concatenating 8 of these set, the 48 bit (6*8) unique MAC address may be represented. In a preamble 908 FIG. 9B, 4 set of short training sequences labeled ST₀ 910, ST₁ 912, ST₂ 914, ST₉ 916 are illustrated, each denoting a string of 6 bit binary ‘1s’ and ‘0s’. This is followed by small number of EoPs 918. In this scheme, the 48 bit MAC address is represented uniquely. FIG. 9B shows 4 set or 24 bits 000000-000001-001001-000010. At the receiver, the AP needs to decode a set of expected sequences by correlating the signal with a number of sequences one after another. It may be seen that the receiver complexity increases accordingly.

PLCP with New Preamble and New SIG/ACK Frame

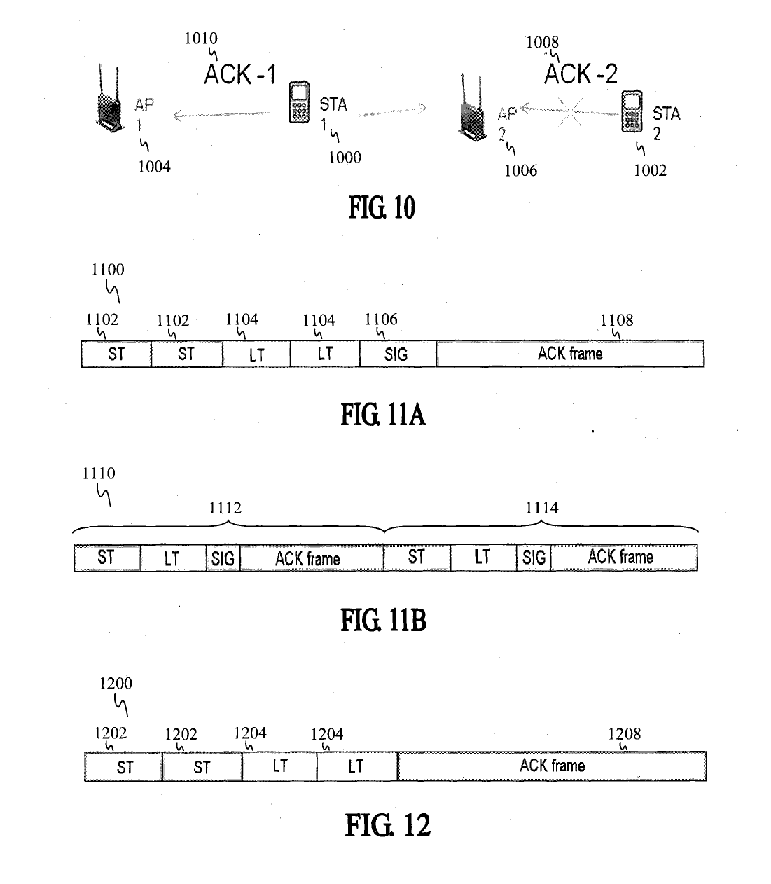

As mentioned above, the preamble only transmission has limited addressing capability and thus may cause interference among multiple stations/APs. To elaborate, an example of such scenario is illustrated in FIG. 10, where two mobiles (STA1 1000 and STA2 1002) are communicating to their respective APs (AP1 1004 and AP2 1006) simultaneously. AP2 1006 is expecting an ACK-2 1008 from STA2 1002. As STA2 1002 does not receive its data for certain reason, it did not send ACK-2 1008. At the same time, STA1 1000 has just received successfully a data packet from AP1 1004 and is replying AP1 1004 an ACK-1 1010. As AP2 1006 is within the range of the STA1 1000 transmission in this scenario, AP2 1006 overhears ACK-1 1010. If AP2 1006 is expecting a preamble only transmission, it would detect only preamble. The overheard preamble in ACK-1 1010 would then take ACK-1 1010 as ACK-2 1008 and causes AP2 1006 erroneously thinking its data has been successfully received by STA2 1002.

Various examples may provide a communication terminal (e.g., mobile) including a message generator configured to generate an ACK message in acknowledge receipt of a message from a communication device (e.g., AP) in a wireless communication network. The ACK message may include a preamble having a plurality of STs and a plurality of LTs.

In order to achieve a substantial gain on uplink control signaling and not to compromise on the addressing capability, an enhanced preamble is needed together with an enhanced SIG/ACK frame as shown in FIG. 11A. In comparison with the original PLCP format in FIG. 4, the new PLCP format 1100 in FIG. 11A has a longer ST 1102 and LT 1104, as well as the SIG 1106 and the ACK frame 1108 so that a higher reliability may be achieved for all parts of the PLCP frame 1100. In FIG. 11A, both ST 1102 and LT 1104 are doubled to achieve approximately 3-dB gain. In other examples, ST 1102 and LT 1104 may also be repeated a number of time in order to have a higher reliability. Furthermore, ST 1102 and LT 1104 may also be redesigned with a longer duration. For example, the current ST (e.g. ST 414 of FIG. 4) contains 10 short training sequences. Instead of having 20 training sequences as in FIG. 11A, the number of sequence may also be kept to 10 but double the length of each sequence. Similarly, long training sequences in LT 1104 may also be lengthened instead of repetition of the original LT (e.g. LT 416 of FIG. 4).

The preamble design 1100 shown in FIG. 11A has minor changes to the current specifications as the basic component or sequence of ST or LT remains the same. Therefore similar detectors with same sequence generators and preamble correlators may be employed at the receivers. In addition, it is easy to coexist with a normal station with original PLCP frame format (as seen in FIG. 4). On one hand, a legacy station following the original PLCP frame format (FIG. 4) would not be able to synchronize to the new PLCP signal (FIG. 11A) as it treats the second LT 1104 in FIG. 11A as a SIG frame (e.g., SIG 412 of FIG. 4) and would not decode successfully. That is a legacy device would not be confused by the new format 1100.

On the other hand, a new device complying with the new PLCP format 1100 as in FIG. 11A is capable of decoding the current frame format (FIG. 4) as well as the new format (FIG. 11A), if needed, with a single set of ST and LT sequence generators or correlators. If the device is interested only in the new PLCP format 1100, it would also be able to differentiate the two types of signals and would not get confused.

As far as the SIG 1106 and ACK frame 1108 are of concern, the MAC frame format for them is kept unchanged. However, their actual durations are lengthened. This is due to more reliable modulation and coding schemes being introduced similar to what have described above. For example, using symbol repetition method as exemplified in FIGS. 7A and 7B, the physical transmission time of SIG and ACK frame may be doubled. When more gains for these two portions are required, the repetition rate needs to be increased. The physical duration of the two parts may be also increased accordingly.

FIG. 11B shows an alternative design 1110 for the new preambles and SIG/ACK frame. In FIG. 11B, instead of repeating each part of PLCP separated, it repeats the whole PLCP frame 1112, 1114. However, it should be understood that the design in FIG. 11B may require buffering data, coexistence with normal preamble devices and having multiple process running due to discontinuous parts.

PLCP without SIG

The PLCP format 1100, 1110 in FIGS. 11A and 11B may be further improved in terms of efficiency as shown in FIG. 12, where the PLCP format 1200 includes 2 sets of ST 1202 and 2 sets of LTs 1204 are used with the SIG field is removed. From FIG. 1, it is observed that the SIG portion 104 is meant to convey the data rate and the frame length. Since the ACK frame 1206 in this scheme is fixed to the most reliable modulation mode, there is no need to exchange data rate and frame length. As such, this transmission time may be saved. In addition, the ACK frame duration may also be shortened and made efficient. The current ACK frame (e.g., 406, FIG. 4) consists of 2-byte control field, 2-byte duration field, 6-byte receiver address field, and 4-byte CRC check. As only the 6 bytes for MAC address are desired, the ACK frame 1206 may be shortened to 6 bytes or 10 bytes corresponding to the MAC address with or without CRC check field if the reliability provide by enhanced PHY mode is sufficient.

WiFi offloading becomes critical technologies for the service provider to shift the mobile data service demand from the legacy cellular networks. However, the link asymmetric caused by transmission power difference at WiFi AP and mobile stations severely limit the coverage of WiFi AP and increases the overall network deployment cost. In the exemplary schemes described above, the enhanced reliability increases the coverage of uplink signaling without increasing the transmission power, thus mitigate the challenges of asymmetric transmission in WiFi offloading networks.

In the context of various embodiments, the term “about” or “approximately” as applied to a numeric value encompasses the exact value and a variance of +/−5% of the value.

The phrase “at least substantially” may include “exactly” and a variance of +/−5% thereof. As an example and not limitation, the phrase “A is at least substantially the same as B” may encompass embodiments where A is exactly the same as B, or where A may be within a variance of +/−5%, for example of a value, of B, or vice versa.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A communication terminal in a wireless communication network, the communication terminal comprising:
a receiver configured to receive a first message comprising a media access control (MAC) frame at a first transmission rate from a communication device in the wireless communication network;
a message generator configured to generate a second message in response to the received first message, the second message comprising a control response frame;
a transmitter configured to transmit the control response frame at a second transmission rate, wherein the second transmission rate is lower than or equal to the first transmission rate; and wherein the second transmission rate is dependent on a difference in qualities between downlink communication and uplink communication between the communication device and the communication terminal.

2. The communication terminal of claim 1, wherein the control response frame comprises frame check sequence (FCS) bits and at least one of an identification of the communication terminal and an identification of the communication device.

3. The communication terminal of claim 1, wherein the difference in quality comprises at least one of a difference in transmission ranges, a difference in transmission power levels, a difference in transmission or receiving antenna gain, a difference in throughputs or coverages, or a difference in connectivities.

4. The communication terminal of claim 1 wherein the second transmission rate is selected from a set of transmission rates for a channel between the communication terminal and the communication device; and wherein each transmission rate in the set is lower than or equal to the first transmission rate.

5. The communication terminal of claim 4, wherein the second transmission rate is selected from the set of transmission rates based on a transmission power, an antenna gain and a capability of the communication terminal.

6. The communication terminal of claim 1, wherein the second message further comprises a first SIGNAL field comprising information on parity check bits and tail bits.

7. (canceled)

8. (canceled)

9. The communication terminal of claim 6, wherein the transmitter is further configured to transmit the first SIGNAL field at a third transmission rate, where the second transmission rate is the same as the third transmission rate; and wherein the first SIGNAL field and the control response frame is arranged to be combined into a single frame or a second SIGNAL field.

10. The communication terminal of claim 9, wherein the single frame or the second SIGNAL field contains tail bits, identification bits and FCS bits; wherein the length of the single frame or the second SIGNAL field is shorter than the combination of the length of the control response frame and the length of the first SIGNAL field.

11. The communication terminal of claim 1, wherein the second message further comprises a preamble comprising a short training field (ST) composed of repetitions of a short training sequence and a long training field (LT) composed of repetitions of a long training sequence.

12. The communication terminal of claim 11, wherein the preamble further comprises the ST and the LT being repeated for 2 times or more in different predetermined orders.

13. (canceled)

14. (canceled)

15. The communication terminal of claim 1, wherein the control response frame comprises any one of an acknowledgement (ACK) frame, a block ACK (BA) frame, or a Clear-to-Send (CTS) frame.

16. The communication terminal of claim 9, wherein the control response frame and the first or the second SIGNAL field comprise a plurality of Orthogonal Frequency-Division Multiplexing (OFDM) symbols, each OFDM symbol comprising a plurality of symbols; and wherein the message generator is further configured to generate the second message using the symbols being repeated in a predetermined order.

17. (canceled)

18. (canceled)

19. The communication terminal of claim 1, wherein the wireless communication network is a communication network according to an IEEE 802.11 communication standard, and wherein the first transmission rate is used to determine a primary rate; and wherein the control response frame has a first frame duration when transmitting at the second transmission rate, the first frame duration being longer than a second frame duration, wherein the second frame duration is determined by transmitting the control response frame at the primary rate.

20. (canceled)

21. A method of modulating a message for transmission in a wireless communication network, the method comprising:
receiving a first message comprising a media access control (MAC) frame at a first transmission rate from a communication device in the wireless communication network;
generating a second message in response to the received first message, wherein the second message comprises a control response frame; and
transmitting the control response frame at a second transmission rate, wherein the second transmission rate is lower than or equal to the first transmission rate; and wherein the second transmission rate is dependent on a difference in qualities between downlink communication and uplink communication between the communication device and the communication terminal.

22. method of claim 21, further comprising transmitting a SIGNAL field at a third transmission rate, wherein the second transmission rate is the same as the third transmission rate.

23. The method of claim 22, wherein the third transmission rate is fixed at a lowest mandatory rate.

24. The method of claim 22, wherein transmitting the control response frame and the SIGNAL field comprises transmitting the control response frame and the SIGNAL field in a single frame or as a new SIGNAL field.

25. The method of claim 22, wherein the control response frame and the SIGNAL field comprise a plurality of Orthogonal Frequency-Division Multiplexing (OFDM) symbols, each OFDM symbol comprising a plurality of symbols; and wherein the method further comprises generating the second message using the symbols being repeated in a predetermined order.

26. The method of claim 25, wherein generating the second message comprises generating the second message using the symbols being repeated for 2 times, or 3 times, or 4 times, or 5 times, or 6 times, or 7 times, or 8 times or more.

27. The method of claim 26, wherein generating the second message comprises generating the second message using the symbols being repeated in different predetermined orders.
